(19) United States
(12) Patent Application Publication
(10) Pub. No.: US 2021/0193041 A1
(43) Pub. Date: Jun. 24, 2021

(54) PIXEL DRIVING CIRCUIT AND DISPLAY DEVICE

(71) Applicant: SeeYA Optronics Co., Ltd., Shanghai (CN)

(72) Inventor: Wenwei XU, Shanghai (CN)

(21) Appl. No.: 17/003,843

(22) Filed: Aug. 26, 2020

(30) Foreign Application Priority Data
Dec. 20, 2019 (CN) 201911329067.9

(51) Int. Cl. G09G 3/3258

(52) U.S. Cl. CPC G09G 3/3258; G09G 2310/08; G09G 2320/066

(57) ABSTRACT

A pixel driving circuit is provided, including: a driving transistor connected between a first power supply terminal and a second power supply terminal; a light-emitting device connected between a third node and a second power supply terminal; a first capacitor having a first terminal connected to a first node and a second terminal connected to a fourth node; a second capacitor having a first terminal connected to the first node; a first switch unit having a first terminal connected to a data signal terminal and a second terminal connected to the fourth node; a second switch unit having a first terminal connected to the second fixed potential terminal and a second terminal connected to the fourth node; and a third switch unit having a first terminal connected to the data signal terminal and a second terminal connected to the first node.

### CROSS-REFERENCE TO RELATED APPLICATION(S)

The present application claims priority to Chinese Patent Application No. 201911329067.9, filed on Dec. 20, 2019, the content of which is incorporated herein by reference in its entirety.

### TECHNICAL FIELD

The present disclosure relates to the field of display technology and, in particular, to a pixel driving circuit and a display device.

### BACKGROUND

Organic light-emitting display devices are also named as organic light-emitting diode (OLED) display devices and have advantages of lightweight, thinness, and large viewing angles compared with liquid crystal display devices. Pixel driving circuits are provided in the organic light-emitting display panel and are configured to control light emission of the light-emitting devices to realize image display.

However, in the current pixel driving circuit, due to process limitations, a voltage amplitude provided to the pixel driving circuit is limited, which may lead to low contrast of the light-emitting devices.

### SUMMARY

Embodiments of the present disclosure provide a pixel driving circuit and a display device, which can improve the contrast of the light-emitting device.

In one aspect, an embodiment of the present disclosure provides a pixel driving circuit, including:

a driving transistor connected in series between a first power supply terminal and a second power supply terminal and including a control terminal electrically connected to a first node, a first terminal electrically connected to a second node, and a second terminal electrically connected to a third node, wherein the second node is located between the first power supply terminal and the driving transistor, and the third node is located between the second power supply terminal and the driving transistor;

a light-emitting device connected in series between the third node and the second power supply terminal;

a first capacitor having a first terminal electrically connected to the first node and a second terminal electrically connected to a fourth node;

a second capacitor having a first terminal electrically connected to the first node and a second terminal electrically connected to a first fixed potential terminal;

a first switch unit having a first terminal electrically connected to a data signal terminal and a second terminal electrically connected to the fourth node;

a second switch unit having a first terminal electrically connected to a second fixed potential terminal and a second terminal electrically connected to the fourth node; and

a third switch unit having a first terminal electrically connected to the data signal terminal and a second terminal electrically connected to the first node.

In another aspect, an embodiment of the present disclosure further provides a display device including the pixel driving circuit above.

The pixel driving circuit and the display device in the embodiments of the present disclosure change the gate voltage of the driving transistor through a principle of capacitive coupling, so that a gate voltage range of the driving transistor becomes larger with respect to a data voltage value range directly provided in the pixel driving circuit, that is, the driving transistor can generate a corresponding driving current under the control of the gate voltage having a larger voltage range, thereby improving the contrast of the light-emitting device.

### BRIEF DESCRIPTION OF DRAWINGS

In order to better illustrate the technical solutions in embodiments of the present disclosure or of the related art, accompanying drawings used in the embodiments or the related art are described below. It is apparent that, the drawings described below are merely some embodiments of the present disclosure. Based on these drawings, those of ordinary skill in the art can obtain other drawings without any creative effort.

FIG. 1 is an equivalent circuit diagram of a pixel driving circuit according to an embodiment of present disclosure;

FIG. 2 is an equivalent circuit diagram of another pixel driving circuit according to an embodiment of the present disclosure;

FIG. 3 is a signal sequence diagram of the pixel driving circuit in FIG. 2.

### DESCRIPTION OF EMBODIMENTS

In order to better illustrate objectives, technical solutions, and advantages of the embodiments of the present disclosure, the technical solutions in the embodiments of the present disclosure will be described clearly and completely in conjunction with the drawings in the embodiments of the present disclosure. It is apparent that, the embodiments described only show a part of the embodiments of the present disclosure, but not all the embodiments. Based on the embodiments of the present disclosure, all other embodiments obtained by those of ordinary skill in the art without any creative effort fall within the protection scope of the present disclosure.

The terms used in the embodiments of the present disclosure are merely for the purpose of describing particular embodiments and not intended to limit the present disclosure.

Unless the context clearly indicates other meanings, the singular form expressions “a”, “an”, “the” and “said” used in the embodiments and appended claims of the present disclosure are also intended to represent the plural form thereof.

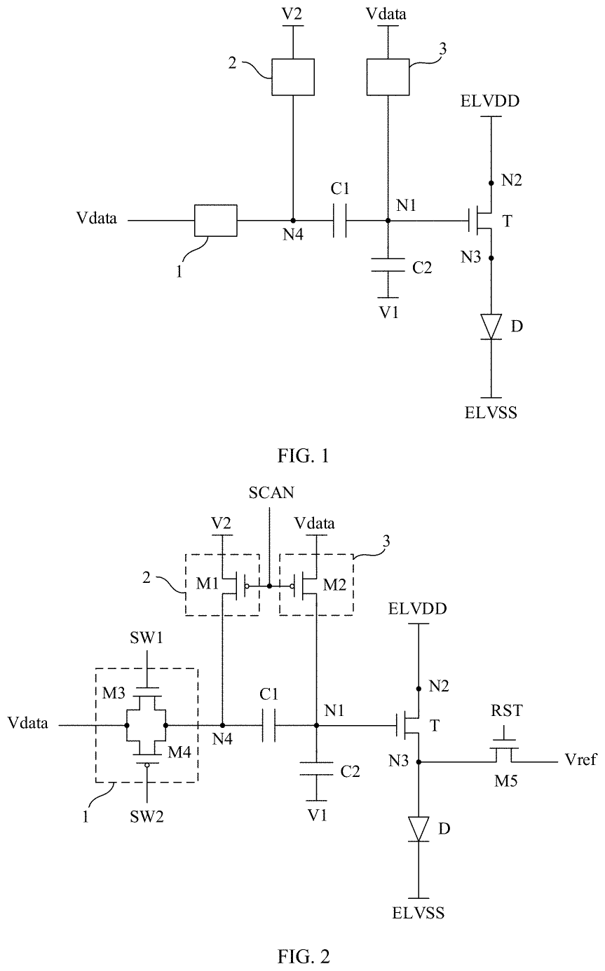

As shown in FIG. 1, FIG. 1 is an equivalent circuit diagram of a pixel driving circuit according to an embodiment of the present disclosure. An embodiment of the present disclosure provides a pixel driving circuit, the pixel driving circuit includes: a driving transistor T connected in series between a first power supply terminal ELVDD and a second power supply terminal ELVSS, a light-emitting device D, a first capacitor C1, a second capacitor C2, a first switch unit 1, a second switch unit 2, and a third switch unit 3. A control terminal of the driving transistor T is electrically connected to a first node N1, that is, a gate of the driving transistor T is electrically connected to the first node N1, a first terminal of the driving transistor T is electrically connected to a second node N2, a second terminal of the driving transistor T is electrically connected to a third node N3, the second node N2 is located between the first power supply terminal ELVDD and the driving transistor T, and the third node N3 is located between the second power supply terminal ELVSS and the driving transistor T. The light-emitting device D is connected in series between the third node N3 and the second power supply terminal ELVSS. The first capacitor C1 has a first terminal electrically connected to the first node N1 and a second terminal electrically connected to a fourth node N4. The second capacitor C2 has a first terminal electrically connected to the first node N1 and a second terminal electrically connected to a first fixed potential terminal V1. The first switch unit 1 has a first terminal electrically connected to a data signal terminal Vdata and a second terminal electrically connected to the fourth node N4. The second switch unit 2 has a first terminal electrically connected to a second fixed potential terminal V2 and a second terminal electrically connected to the fourth node N4. The third switch unit 3 has a first terminal electrically connected to the data signal terminal Vdata and a second terminal electrically connected to the first node N1.

Specifically, a working time sequence of the pixel driving circuit sequentially includes an initialization phase tl, a data writing phase t2, and a light-emitting phase t3: in the initialization phase tl, the first switch unit 1 is controlled to be turned off, the second switch unit 2 is controlled to be turned on, so that a voltage V2 of the second fixed potential terminal V2 is transmitted to the fourth node N4 through the second switch unit 2, and at this time, a voltage at the fourth node N4 is the voltage V2, the third switch unit 3 is controlled to be turned on, so that a voltage V_{data} of the data signal terminal Vdata is transmitted to the first node N1 through the third switch unit 3, and at this time, a voltage at the first node N1 is the voltage V_{data}; in the data writing phase t2, the first switch unit 1 is controlled to be turned on, so that the voltage V_{data} of the data signal terminal Vdata is transmitted to the fourth node N4 through the first switch unit 1, and at this time, the voltage at the fourth node N4 changes from the voltage V₂ to the voltage V_{data}, an amount of change of the voltage at the fourth node N4 is V_{data}−V₂, the second switch unit 2 and the third switch unit 3 are controlled to be turned off, due to a coupling effect between the first capacitor C1 and the second capacitor C2, a potential at the first node N1 changes from the voltage V_{data} to the voltage

$$( {V}_{d a t a} + Δ V ) , and Δ V = \frac{{C}_{1}}{{C}_{1} + {C}_{2}}$$

$$( {V}_{data} - {V}_{2} ) ,$$

where C₁ is a capacitance value of the first capacitor C1, and C₂ is a capacitance value of the second capacitor C2; in the light-emitting phase t3, the first switch unit 1, the second switch unit 2 and the third switch unit 3 are controlled to be turned off, the driving transistor T generates a corresponding driving current based on the voltage at the first node N1, to drive the light-emitting device D to emit light. For example, it is assumed that V₂=6V, the minimum voltage value that the data signal terminal Vdata can provide is 0V, then correspondingly the voltage at the first node

$$N 1 is - \frac{{C}_{1}}{{C}_{1} + {C}_{2}} 6 V ,$$

and the maximum voltage value that the data signal terminal Vdata can provide is 6V, then correspondingly the voltage at the first node N1 is 6V. It can be seen that, relative to a voltage value range provided by the data signal terminal Vdata, a voltage value range at the first node N1 is larger, that is, the driving transistor T can generate a corresponding driving current under control of a gate voltage having a larger voltage range, thereby improving contrast of the light-emitting device D.

The pixel driving circuit in the embodiments of the present disclosure, through cooperation of the first switch unit, the second switch unit, the third switch unit and the first capacitor, and through the principle of capacitive coupling, changes the gate voltage of the driving transistor, to facilitate the gate voltage range of the driving transistor become larger with respect to the data voltage value range directly provided in the pixel driving circuit, that is, the driving transistor can generate a corresponding driving current under the control of the gate voltage having a larger voltage range, thereby improving the contrast of the light-emitting device.

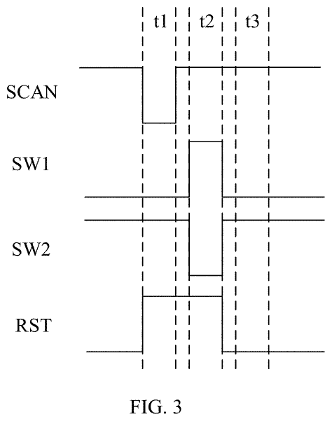

Optionally, as shown in FIGS. 2 and 3, FIG. 2 is an equivalent circuit diagram of another pixel driving circuit according to an embodiment of the present disclosure, and FIG. 3 is a signal sequence diagram of the pixel driving circuit in FIG. 2. The second switch unit 2 includes a first transistor M1, a first terminal of the first transistor M1 is electrically connected to the second fixed potential terminal V2, a second terminal of the first transistor M1 is electrically connected to the fourth node N4, and a control terminal of the first transistor M1 is electrically connected to a scan signal terminal SCAN. The third switch unit 3 includes a second transistor M2, a first terminal of the second transistor M2 is electrically connected to the data signal terminal Vdata, a second terminal of the second transistor M2 is electrically connected to the first node N1, and a control terminal of the second transistor M2 is electrically connected to the scan signal terminal SCAN.

Specifically, the first transistor M1 and the second transistor M2 may be transistors of the same type, for example, both are N-type transistors, or both are P-type transistors, and controlling of the first transistor M1 and the second transistor M2 can be achieved by the same scan signal terminal SCAN.

Optionally, as shown in FIGS. 2 and 3, the first switch unit 1 includes: a third transistor M3 and a fourth transistor M4. The third transistor M3 is an N-type transistor, a first terminal of the third transistor M3 is electrically connected to the data signal terminal Vdata, a second terminal of the third transistor M3 is electrically connected to the fourth node N4, and a control terminal of the third transistor M3 being electrically connected to a first control signal terminal SW1. The fourth transistor M4 is a P-type transistor, a first terminal of the fourth transistor M4 is electrically connected to the data signal terminal Vdata, a second terminal of the fourth transistor M4 is electrically connected to the fourth node N4, and a control terminal of the fourth transistor M4 is electrically connected to a second control signal terminal SW2.

Specifically, the third transistor M3 and the fourth transistor M4 form a transmission gate, and both are turned off and turned on at the same time, so as to improve the transmission effect of the data signal.

Optionally, as shown in FIGS. 2 and 3, the pixel driving circuit further includes: a fifth transistor M5, a first terminal of the fifth transistor M5 is electrically connected to a reference voltage terminal Vref, a second terminal of the fifth transistor M5 is electrically connected to the third node N3, and a control terminal of the fifth transistor M5 is connected to a reset control terminal RST. The fifth transistor M5 is configured to achieve reset of the anode of the light-emitting device D to improve the display effect.

Optionally, the driving transistor T is an N-type transistor, the source of the driving transistor T is electrically connected to the third node N3, the driving current value of the driving transistor T is related to a gate-source voltage difference, that is, related to a voltage difference between the first node N1 and the third node N3, so that the problem that the voltage difference between the first node N1 and the third node N3 is small is more likely to occur.

As shown in FIGS. 2 and 3, an embodiment of the present disclosure provides a pixel driving circuit, the pixel driving circuit includes: a driving transistor T connected in series between a first power supply terminal ELVDD and a second power supply terminal ELVSS, a light-emitting device D, a first capacitor C1, a second capacitor C2, a first transistor M1, a second transistor M2, a third transistor M3, and a fourth transistor M4. A control terminal of the driving transistor T is electrically connected to a first node N1, a first terminal of the driving transistor T is electrically connected to a second node N2, a second terminal of the driving transistor T is electrically connected to a third node N3, the second node N2 is located between the first power supply terminal ELVDD and the driving transistor T, and the third node N3 is located between the second power supply terminal ELVSS and the driving transistor T. The light-emitting device D is connected in series between the third node N3 and the second power supply terminal ELVSS. The first capacitor C1 has a first terminal electrically connected to the first node N1 and having a second terminal electrically connected to the fourth node N4; a second capacitor C2 having a first terminal electrically connected to the first node N1 and a second terminal electrically connected to a first fixed potential terminal V1. The first transistor M1 has a first terminal electrically connected to a second fixed potential terminal V2, a second terminal electrically connected to the fourth node N4, and a control terminal electrically connected to a scan signal terminal SCAN. The second transistor M2 has a first terminal electrically connected to a data signal terminal Vdata, a second terminal electrically connected to the first node N1, and a control terminal electrically connected to the scan signal terminal SCAN. The third transistor M3 is an N-type transistor, a first terminal of the third transistor M3 is electrically connected to the data signal terminal Vdata, a second terminal of the third transistor M3 is electrically connected to the fourth node N4, and a control terminal of the third transistor M3 is electrically connected to a first control signal terminal SW1. The fourth transistor M4 is a P-type transistor, a first terminal of the fourth transistor M4 is electrically connected to the data signal terminal Vdata, a second terminal of the fourth transistor M4 is electrically connected to the fourth node N4, and a control terminal of the fourth transistor M4 is electrically connected to a second control signal terminal SW2. The working time sequence of the pixel driving circuit sequentially includes the initialization phase t1, the data writing phase t2 and the light-emitting phase t3: in the initialization phase t1, a turn-on level is provided to the scan signal terminal SCAN, taking the case that the first transistor M1 and the second transistor M2 are P-type transistors as an example, the turn-on level is a low level, the first transistor M1 and the second transistor M2 are controlled to be turned on, so that the voltage V2 of the second fixed potential terminal V2 is transmitted to the fourth node N4 through the first transistor M1, and at this time, the voltage at the fourth node N4 is the voltage V2, so that the voltage V_{data} of the data signal terminal Vdata is transmitted to the first node N1 through the second transistor M2, and at this time, the voltage at the first node N1 is the voltage V_{data}, a low level is provided to the first control signal terminal SW1, to control the third transistor M3 to be turned off, and a high level is provided to the second control signal terminal SW2, to control the fourth transistor M4 to be turned off; in the data writing phase t2, a turn-off level is provided to the scan signal terminal SCAN, taking the case that the first transistor M1 and the second transistor M2 are P-type transistors for example, the turn-off level is a high level, to control the first transistor M1 and the second transistor M2 to be turned off, a high level is provided to the first control signal terminal SW1, to control the third transistor M3 to be turned on, and a low level is provided to the second control signal terminal SW2, to control the fourth transistor M4 to be turned on, so that the voltage V_{data} of the data signal terminal Vdata is transmitted to the fourth node N4 through the third transistor M3 and the fourth transistor M4, and an amount of change of the voltage at the fourth node N4 is V_{data}−V₂, due to the coupling effect of the first capacitor C1 and the second capacitor C2, the potential at the first node N1 changes from V_{data} to V_{data}+ΔV,

$$Δ V = \frac{{C}_{1}}{{C}_{1} + {C}_{2}} ( {V}_{d a t {a}^{-}} {V}_{2} ) ;$$

in the light-emitting phase t3, a turn-off level is provided to the scan signal terminal SCAN, to control the first transistor M1 and the second transistor M2 to be turned off, a low level is provided to the first control signal terminal SW1, to control the third transistor M3 to be turned off, and a high level is provided to the second control signal terminal SW2, to control the fourth transistor M4 to be turned off. It is assumed that the minimum voltage value that the data signal terminal Vdata can provide is 0V, then correspondingly the voltage at the first node

$$N 1 is - \frac{{C}_{1}}{{C}_{1} + {C}_{2}} {V}_{2} ,$$

the maximum voltage value that the data signal terminal Vdata can provide is the voltage V₂, then correspondingly the voltage at the first node N1 is the voltage V₂. Thus, it can be seen that, relative to a voltage value range provided by the data signal terminal Vdata, a voltage value range at the first node N1 is larger, that is, the driving transistor T can generate a corresponding driving current under the control of the gate voltage having a larger voltage range, thereby improving the contrast of the light-emitting device D.

The pixel driving circuit in the embodiments of the present disclosure, through cooperation of the first transistor, the second transistor, the third transistor and the first capacitor, and through the principle of capacitive coupling, changes the gate voltage of the driving transistor, to facilitate the gate voltage range of the driving transistor become larger with respect to the data voltage value range directly provided in the pixel driving circuit, that is, the driving transistor can generate a corresponding driving current under the control of the gate voltage having a larger voltage range, thereby improving the contrast of the light-emitting device.

Optionally, the pixel driving circuit further includes: a fifth transistor M5, a first terminal of the fifth transistor M5 is electrically connected to a reference voltage terminal Vref, a second terminal of the fifth transistor M5 is electrically connected to the third node N3, and a control terminal of the fifth transistor M5 is electrically connected to a reset control terminal RST. In the initialization phase tl, the turn-on level is provided to the reset control terminal RST, taking the case that the fifth transistor M5 is an N-type transistor for example, the turn-on level is a high level, to control the fifth transistor M5 to be turned on, such that the voltage of the reference voltage terminal Vref is transmitted to the third node N3 through the fifth transistor M5, to reset the anode of the light-emitting device D; in the data writing phase t2, a turn-on level is provided to the reset control terminal RST, to control the fifth transistor M5 to be turned on, such that the voltage of the reference voltage terminal Vref is transmitted to the third node N3 through the fifth transistor M5; in the light-emitting phase t3, a turn-off level is provided to the reset control terminal RST, to control the fifth transistor M5 to be turned off.

An embodiment of the present disclosure further provides a display device, and it includes the above pixel driving circuit.

The specific structure and principle of the pixel driving circuit are the same as those in the above embodiments and will not be repeated here. The display device may be any electronic device having a display function, such as a touch screen, a mobile phone, a tablet computer, a laptop, or a television.

The display device in the embodiments of the present disclosure can keep the voltage of the node between the driving transistor and the light-emitting device unchanged during the light-emitting phase, so that the driving current generated by the driving transistor will not be affected by the change of the voltage across the two terminals of the light-emitting device, thereby solving the problem of uneven display due to the change in the voltage across the two terminals of the light-emitting device.

Optionally, the display device is a silicon-based micro display device, a size of the silicon-based micro display device is generally smaller than 1 inch, and an area of a single pixel is dozens of square microns.

Finally, it should be noted that the various embodiments above are only preferred embodiments used to illustrate the technical solutions of the present disclosure, rather than providing any limitation. Although the present disclosure has been described in detail with reference to the various embodiments above, those of ordinary skill in the art should understand that: they can still modify the technical solutions described in the various embodiments above or equivalently replace some or all of the technical features, while these modifications or replacements do not cause the essence of the corresponding technical solutions to depart from the scope of the technical solutions of the various embodiments of the present disclosure.

What is claimed is:

1. A pixel driving circuit, comprising:
a driving transistor connected in series between a first power supply terminal and a second power supply terminal and comprising a control terminal electrically connected to a first node, a first terminal electrically connected to a second node, and a second terminal electrically connected to a third node, wherein the second node is located between the first power supply terminal and the driving transistor, and the third node is located between the second power supply terminal and the driving transistor;
a light-emitting device connected in series between the third node and the second power supply terminal;
a first capacitor having a first terminal electrically connected to the first node and a second terminal electrically connected to a fourth node;
a second capacitor having a first terminal electrically connected to the first node and a second terminal electrically connected to a first fixed potential terminal;
a first switch unit having a first terminal electrically connected to a data signal terminal and a second terminal electrically connected to the fourth node;
a second switch unit having a first terminal electrically connected to a second fixed potential terminal and a second terminal electrically connected to the fourth node; and
a third switch unit having a first terminal electrically connected to the data signal terminal and a second terminal electrically connected to the first node.

2. The pixel driving circuit according to claim 1, wherein the pixel driving circuit has an operation timing sequentially comprising an initialization phase, a data writing phase, and a light-emitting phase:
in the initialization phase, the first switch unit is controlled to be turned off, and the second switch unit is controlled to be turned on, so that a voltage of the second fixed potential terminal is transmitted to the fourth node through the second switch unit, and the third switch unit is controlled to be turned on, so that a voltage of the data signal terminal is transmitted to the first node through the third switch unit;
in the data writing phase, the first switch unit is controlled to be turned on, so that the voltage of the data signal terminal is transmitted to the fourth node through the first switch unit, and the second switch unit and the third switch unit are controlled to be turned off; and
in the light-emitting phase, the first switch unit, the second switch unit and the third switch unit are controlled to be turned off.

3. The pixel driving circuit according to claim 1, wherein the second switch unit comprises a first transistor, a first terminal of the first transistor is electrically connected to the second fixed potential terminal, a second terminal of the first transistor is electrically connected to the fourth node, and a control terminal of the first transistor is electrically connected to a scan signal terminal; and
the third switch unit comprises a second transistor, a first terminal of the second transistor is electrically connected to the data signal terminal, a second terminal of the second transistor is electrically connected to the first node, and a control terminal of the second transistor is electrically connected to the scan signal terminal.

4. The pixel driving circuit according to claim 1, wherein the first switch unit comprises:
a third transistor, the third transistor being an N-type transistor and having a first terminal electrically connected to the data signal terminal, a second terminal electrically connected to the fourth node, and a control terminal electrically connected to a first control signal terminal; and
a fourth transistor, the fourth transistor being a P-type transistor and having a first terminal electrically connected to the data signal terminal, a second terminal electrically connected to the fourth node, and a control terminal electrically connected to a second control signal terminal.

5. The pixel driving circuit according to claim 1, further comprising:
a fifth transistor having a first terminal electrically connected to a reference voltage terminal, a second terminal electrically connected to the third node, and a control terminal electrically connected to a reset control terminal.

6. The pixel driving circuit according to claim 1, wherein the driving transistor is an N-type transistor.

7. A display device, comprising the pixel driving circuit according to claim 1.

8. The display device according to claim 7, wherein the display device is a silicon-based micro display device.

9. A pixel driving circuit, comprising:
a driving transistor connected in series between a first power supply terminal and a second power supply terminal and having a control terminal electrically connected to a first node, a first terminal electrically connected to a second node, and a second terminal electrically connected to a third node, wherein the second node is located between the first power supply terminal and the driving transistor, and the third node is located between the second power supply terminal and the driving transistor;
a light-emitting device connected in series between the third node and the second power supply terminal;
a first capacitor having a first terminal electrically connected to the first node and a second terminal electrically connected to a fourth node;
a second capacitor having a first terminal electrically connected to the first node and a second terminal electrically connected to a first fixed potential terminal;
a first transistor having a first terminal electrically connected to a second fixed potential terminal, a second terminal electrically connected to the fourth node, and a control terminal electrically connected to a scan signal terminal;
a second transistor having a first terminal electrically connected to a data signal terminal, a second terminal electrically connected to the first node, and a control terminal electrically connected to the scan signal terminal;
a third transistor, the third transistor being an N-type transistor and having a first terminal electrically connected to the data signal terminal, a second terminal electrically connected to the fourth node, and a control terminal electrically connected to a first control signal terminal; and
a fourth transistor, the fourth transistor being a P-type transistor and having a first terminal electrically connected to the data signal terminal, a second terminal electrically connected to the fourth node, and a control terminal electrically connected to a second control signal terminal;
wherein the pixel driving circuit has an operating timing sequence sequentially comprising an initialization phase, a data writing phase and a light-emitting phase in sequence:
in the initialization phase, a turn-on level is provided to the scan signal terminal to control the first transistor and the second transistor to be turned on, so that a voltage of the second fixed potential terminal is transmitted to the fourth node through the first transistor, and a voltage of the data signal terminal is transmitted to the first node through the second transistor, wherein a low level is provided to the first control signal terminal to control the third transistor to be turned off, and a high level is provided to the second control signal terminal to control the fourth transistor to be turned off;
in the data writing phase, a turn-off level is provided to the scan signal terminal to control the first transistor and the second transistor to be turned off, a high level is provided to the first control signal terminal to control the third transistor to be turned on, and a low level is provided to the second control signal terminal to control the fourth transistor to be turned on, so that a voltage of the data signal terminal is transmitted to the fourth node through the third transistor and the fourth transistor; and
in the light-emitting phase, a turn-off level is provided to the scan signal terminal to control the first transistor and the second transistor to be turned off, a low level is provided to the first control signal terminal to control the third transistor to be turned off, and a high level is provided to the second control signal terminal to control the fourth transistor to be turned off.

10. The pixel driving circuit according to claim 9, further comprising:
a fifth transistor having a first terminal electrically connected to a reference voltage terminal, a second terminal electrically connected to the third node, and a control terminal electrically connected to a reset control terminal;
wherein in the initialization phase, a turn-on level is provided to the reset control terminal to control the fifth transistor to be turned on, so that a voltage of the reference voltage terminal is transmitted to the third node through the fifth transistor;
in the data writing phase, a turn-on level is provided to the reset control terminal to control the fifth transistor to be turned on, so that the voltage of the reference voltage terminal is transmitted to the third node through the fifth transistor; and
in the light-emitting phase, a turn-off level is provided to the reset control terminal to control the fifth transistor to be turned off.
